(19) United States
(12) Patent Application Publication
(10) Pub. No.: US 2004/0012670 A1
(43) Pub. Date: Jan. 22, 2004

(54) Combined colour 2d/3d imaging

(76) Inventor: Yun Zhang, New Brunswick (CA)

Correspondence Address: STIKEMAN ELLIOTT, 1600-50 O'CONNOR STREET, OTTAWA, ON, KIP LS2, CA

(21) Appl. No.: 10/398,371

(22) PCT Filed: Oct. 4, 2001
(86) PCT No.: PCT/CA01/01404

(51) Int. Cl. H04N 15/00

(52) U.S. Cl. 348/46; 348/144

(57) ABSTRACT

A combined colour 2D/3D image includes an image medium, a first image of an object including a first colour band on said medium, a second image of the object including second and third colour bands, the first colour band overlaid on the second and third colour bands and in registration therewith, whereby the combined image appears as a clear 2D image when viewed without a complementary colour filter and as a 3D image when viewed with such a filter.

### FIELD OF THE INVENTION

This invention relates to the fields of photogrammetry and remote sensing, and in particular to stereoscopic imaging.

### DISCUSSION OF THE PRIOR ART

Stereoscopic (3D) imaging is well known. Several methods are used to form a 3D image using two complementary two dimensional (2D) colour or black and white images of the same object or objects taken from two different viewing locations. In one method, the two images are spaced a certain distance apart and brought to a particular focal distance to enable a stereoscopic effect in the “overlap area” to be obtained. A stereo viewer is used to properly position the stereo pairs but the image pair, however, is not overlain.

Stereo images can also be generated using (1) Digital Elevation Model DEM)-based 3D and (2) Ariaglyph 3D technologies. With DEM-based 3D, there is no 2D image effect and measurements cannot be made in 2D. With Anaglyph 3D, a conventional black and white stereo image pair is overlain on a printed medium or displayed on a computer monitor. A print screen of an anaglyph displayed on a computer monitor is shown in FIG. 1. The anaglyph has been generated using an airborne frame sensor with a “conventional viewing angle”. The stereoscopic effect in the anaglyph can be observed via a computer monitor or printed on a piece of paper when stereoscopic filters are used. While the 3D image is dear when viewed through filters, the 2D image viewed without filters is blurred. Image measurements cannot be made on the 2D image. The blurred nature of the 2D image has not been of concern in the past because photogrammetric measurements using anaglyphs have hitherto been made using only the 3D image. The blurring of the 2D image is caused by the nature of conventional spaceborne/airborne based imaging.

A colour 3D image can be produced on a computer monitor by overlaying two colour images using conventional software such as is available from PCI ERDAS, or other photogrammetric software. The resulting image, however, contains six colour bands (three from each colour image) and must be polarized and viewed with expensive polarization filters in order to see a 3D effect. The image viewed without the filters is blurred. Furthermore, the total data size of the overlaid image is the size of the two colour images. The 3D image cannot be viewed when they printed on a piece of paper.

Conventional spaceborne/airborne based photogrammetric stereo imaging (including when a frame sensor or linear sensor is used) uses a large viewing angle (20-30 degrees or more) for individual objects to ensure the accurate measure the parallaxes on a stereo image pair and to generate a DEM. Such large viewing angles, however, blur the 2D image when the images are overlain using conventional methods to produce a 3D image.

Conventional non-photogrammetric camera/video imaging can also be used to produce a 3D image. Such imaging usually has a short object distance, with an object depth that is very large. The ratio of object depth to object distance (depth/distance ratio) in such cases can be greater than 1:2. The greater the depth/distance ratio for a set of stereo image pairs, the larger the parallax, even when the viewing angle happens to be small. When parallax is easily seen on a 2D image produced from a stereo pair, it will appear blurred.

A conventional non-photogrammetric camera/video based system for creating 3D images is disclosed in U.S. Pat. No. 4,134,644 issued to Marks et al. on Jan. 16, 1979. In Marks, the same object is pictured from two different viewing angles and the 3D colour effect is perceived using a pair of complementary colour glasses. When a frame camera or video recorder is used as disclosed in Marks, the scale of the tilted image is not constant and thus the parallaxes of the object on the two sides of the image are enlarged. Consequently, when the image in Marks is viewed without the complementary glasses, objects on the 2D image varying greatly in depth will appear blurred.

It would be desirable to have a combined 2D/3D image product and method which permits substantially clear viewing in both 2D and 3D.

### GENERAL DESCRIPTION OF THE INVENTION

The object of the present invention is to meet the above-identified need by providing a relatively simple image product which can be viewed in 2D without stereo viewers and in 3D with stereo viewers. The 2D image looks like a normal 2D image when viewed without stereo glasses, and the 3D image can be perceived when viewed with a pair of complementary stereo glasses.

Accordingly, the invention relates to a combined colour 2D/3D image which includes an image medium, a first image of an object including a first colour band on said medium, a second image of said object including second and third colour bands spaced first colour band overlaid on said second and third colour bands and in registration therewith sufficient to achieve parallax, whereby the combined image appears as a substantially dear 2D image when viewed without a complementary colour filter and as a 3D image when viewed with such a filter.

In another embodiment, the invention relates to a method for forming a combined 2D/3D colour image of an object including the steps of producing a first image of said object from a first viewing angle using a firs colour band; producing a second image of said object from a second viewing angle using second and third colour bands; overlaying and registering said first and second images on a medium, being such that the colour image appears as a substantially clear 2D image when viewed without a complementary filter, and as a 3D image when viewed with such a filter.

In a further embodiment, the present invention relates to a method of collecting a ground image pair using an airborne or spaceborne sensor including the steps of: producing a first image of the ground from a first viewing angle, producing a second image of the ground from a second viewing angle, wherein the angular difference between said viewing angles is between 0 and 5 degrees.

### BRIEF DESCRIPTION OF THE DRAWINGS

The invention is described below in greater detail with reference to the accompanying drawings, which illustrate preferred embodiments of the present invention, and wherein

FIG. 1 is a 2D representation of an anaglyph generated using a black and white stereo image pair collected with an airborne frame sensor using a conventional viewing angle;

FIG. 2 is a black and white reproduction of a combined colour 2D/3D image according to the present invention;

FIGS. 3a and 3b are diagrams showing image recording with a linear sensor according to the present invention;

FIG. 4 is a diagram showing the principle of overlaying multispectral bands and viewing 2D and 3D images according to the present invention;

FIG. 5a is a diagram showing image generation using a frame sensor according to the present invention;

FIG. 5b is a diagram showing the relationship between airbase B and overlay percentage OP according to the present invention;

FIG. 5c is a diagram showing stereo pairs taken along the flying track according tot he present invention; and

FIG. 5d is a diagram showing a stereo pair taken across the flying track according to the present invention

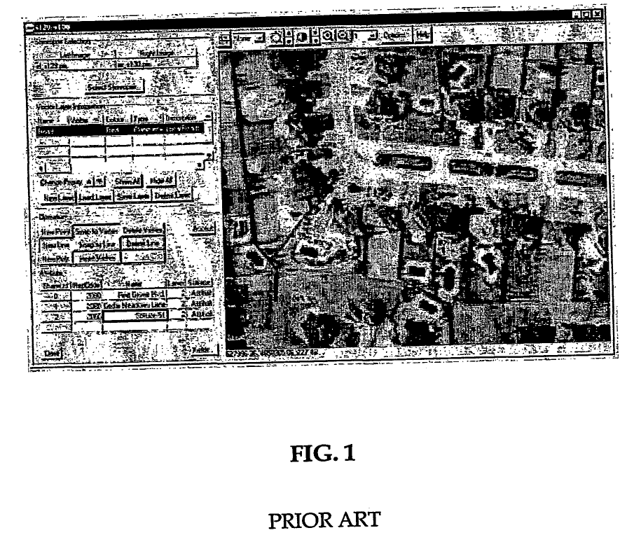

### DETAILED DESCRIPTION OF THE PREFERRED EMBODIMENT

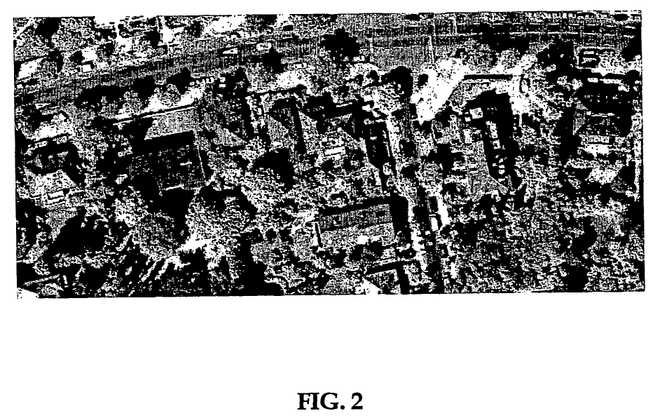

In the preferred embodiment, the composite 2D/3D image contains both colour 2D information and colour 3D information. Referring to FIG. 2, the combined image can be used as a normal 2D colour image map for image measurements and the same image can also be used as a 3D colour image to see colour 3D information when a pair of inexpensive complementary colour stereo glasses are used. This image can be displayed on a computer monitor, saved as a digital file, transferred via the Internet, and printed on a piece of paper. The data size of the 2D/3D colour image is equivalent to a normal 2D colour image. For routine production, near-real-time 2D/3D images can be generated at a very low price similar to that of a normal 2D colour image.

In the preferred embodiment of the invention, ground images are obtained using satellite based conventional linear charge-coupled-device (CCD) sensors. Because of the small depth/distance ratio for satellite imaging, it is possible to adjust the viewing angle according to the present invention to produce a multispectral image with both a substantially dear colour 2D and 3D image.

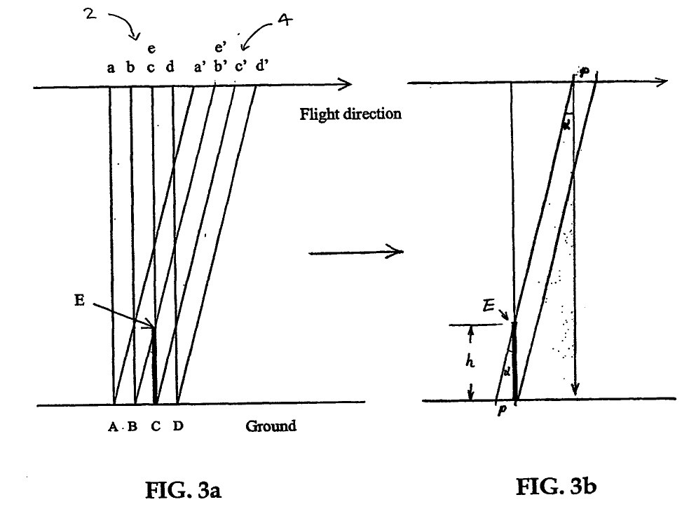

Referring to FIG. 3a, the collection of a stereo pair using a linear CCD sensor includes first collecting a nadir image (the optical axis perpendicular to the ground). The objects on the ground, A, B, C, D and E, are imaged as a, b, c, d and e on the nadir image generally indicated at Z The sensor then turns backwards slightly and images the same ground objects A, B, C, D and E as a′, b′, c′, d′ and e′ on the corresponding tilted image generally indicated at 4 of the pair. Note that the object E is located on the ground at the same place as C, but is not imaged at the same position on each image of the corresponding image pair.

The tilted image can also be collected before taking the nadir images by tilting the sensor slightly forwardly. The selection between forward imaging and backward imaging is dependent on the direction of the sunlight incidence. For example, when the areas to be imaged are located in the northern part of the Earth, backward imaging is preferred as the corresponding image pair for most high-resolution satellites. This is because backward imaging can, in most cases, take images on the sunny side of objects.

It will be understood that the stereo images can also be generated by a slightly forward tilted and backward tilted image pair. However, the advantage of using a nadir image as one image of an image pair is that a 2D image generated from the image pair will have the ortho-image effect. This is important for image mapping purposes. On the other hand, the nadir image can also be used for other purposes such as where a 2D vertical photo or ortho-photo is desired.

In the preferred embodiment, a combined 2D/3D colour image according to the invention can be produced when the following conditions are met:

(1) the image is composed of blue, green and red colour bands (for displaying colour information);

(2) the three bands are collected from two different viewing angles, one band from one angle and two bands from another angle (for obtaining colour stereo information). A colour 3D image can also be generated when the three bands are collected from three different viewing angles. However, the 2D and 3D colour effect will be not as clear as that from two viewing angles; and

(3) the parallaxes of the majority of the objects in the image created by the two viewing angles are minimized, such that the parallax is not easily seen in the 2D colour image and the 3D effect can still be perceived.

When the colour image is composed of green from one viewing angle and blue and red from another viewing angle, a pair of green-magenta (or red-cyan) complementary stereo glasses can be used to see the colour 3D colour image. Some types of stereo glasses, such as red-cyan and red-green glasses, have been produced for conventional monochrome 3D viewing and can be used if a black and white image pair is used.

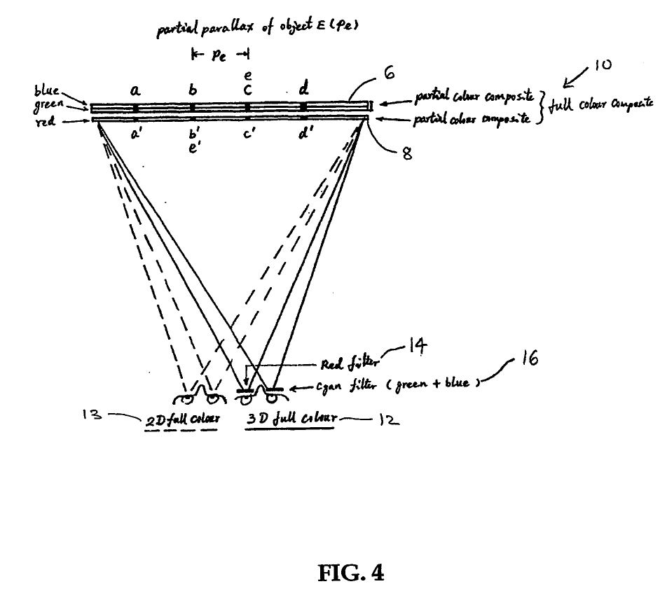

Referring to FIG. 4, when a CCD nadir image 6 is taken with the red band, and a backward image (or forward image) 8 is taken using the green band and blue band separately. In FIG. 4, the bands in images 6 and 8 are shown separated for illustration purposes. A combined natural colour 2D/3D image generally indicated at 10 is generated by overlaying and registering the three bands according to features on the ground. The natural colour is generated by the red, green, and blue bands. The 3D colour image generally indicated at 12 can be perceived by using a pair of complementary filter glasses having red 14 and cyan (green+blue) 16 filters (complementary colour filter) because of the parallax of the objects. The parallax of object E imaged as e and e′ on the nadir image 6 and backward image 8 respectively is depicted as pₑ. A full colour 2D image 13 can be perceived without the glasses.

Alternatively, the green band can be used as the nadir image and the red band and blue band as the tilted image. To perceive the colour 3D effect, green and magenta (red+blue) glasses are used. A combined colour 2D and 3D image can also be generated by using green and blue bands as the nadir image and the red band as the tilted image, or using red and blue bands as the nadir and green as tilted. Consequently, the colour combination of the complementary filter to view the colour 3D image has to be changed accordingly. The colour band combination may also be selected according to the colour of the real objects in the scene, e.g. whether two bands from the nadir or one band from the nadir, as well as which colour from nadir, and which colour from the backward image.

A colour 3D image can generally be generated by using any combination of red, green and blue bands, when the viewing angle between the bands is as described below, and when a pair of complementary stereo glasses is used, e.g. red-cyan for the combination of red band overlaid with green and blue bands; green-magenta for green band overlaid by red and blue bands; or blue-yellow for blue band overlaid by red and green bands. One pair of stereo glasses might have better 3D and colour effect than the other two depending on the colour composition of objects on the image. The density of each filter or the intensity and saturation of each colour may also influence the perception of 3D and colour effect.

The third (3) condition above, is important in causing the 3D image to have the appearance of a 2D image. Because the human eye is very sensitive to the perception of object depths through parallaxes, but not as sensitive to small parallaxes in a 2D image, properly minimizing the parallaxes of the 2D image can greatly improve the quality of the 2D image, without disturbing the 3D perception. This makes it possible to generate a combined 2D and 3D colour image.

The parallax is minimized by minimizing the viewing angle of the stereo images depending on the object heights on the ground. The higher the objects, the smaller the angle. FIG. 2 is a black and white representation of a natural colour combined 2D and 3D image generated according to the method of the present invention using an airborne linear CCD image pair (Nadir image: green band; Tilted image: red band and blue band; Viewing angle: 3.5 degrees). The colour 3D effect can be seen by using red-cyan and green-magenta glasses.

When a linear sensor is used for the image collection, the image scale for the whole tilted image stays constant. This is essential for the generation of a combined 2D and 3D image as the parallax of the objects with the same height can be kept unchanged over the whole image. Consequently, the parallax on the 2D image can remain quite small over the whole image, such that the 2D image is not blurred by the parallaxes, and the colour 3D effect can be dearly perceived.

North-oriented colour combined 2D/3D images can also be generated in accordance with the invention Since most earth observation satellites have a high latitude orbit to offer the greatest coverage of the Earth's surface, it is difficult to generate a north-oriented stereo image using a pair of along-track stereo images (forward and/or backward tilted images). However, because of the very small ratio of field of view (FOV) to orbit height (H) for the satellite imaging (For example, FOV/H<<1/100 assuming H=400-800 km and FOV=10-60 km), the scale of the image does not visibly change when the linear sensor tilts slightly sideward. This enables the generation of a north oriented colour 2D and 3D image by using the side looking image pair. A north oriented stereo image is useful because it meets more of the criteria of standard mapping.

Method for Production Using Linear Sensors

The use of commercial high-resolution satellite imagery for producing combined 2D/3D colour images/image maps is preferred because:

(1) In commercial high-resolution satellites such as IKONOS™, Orbview™ and QuickBird™, the viewing angle can be altered to point to targets within ±45° about the nadir axis;

(2) Such satellites deliver multi-spectral images in blue, green, red and infrared spectral regions; and

(3) The imagery is collected by a CCD linear sensor. Such a sensor is preferred because tilted images can be produced in which the image scale is constant throughout the image. Maintaining the image scale constant is important in the present invention so that the parallax of objects with the same height can be kept unchanged over the whole image. The use of a linear sensor also makes it possible to produce an excellent colour 2D and 3D image mosaic by “sewing” together the neighbouring stereo strips which contain the same band combination, and in which the tilted images have the same viewing angle.

By imaging the same ground objects from two slightly different viewing angles, (such as one nadir and one slightly backward), selecting an appropriate angle difference between image pairs according to the invention, and by selecting two colour bands from the nadir and the third band from the backward angle, a combined 2D/3D colour image can be generated. To get an optimal 2D colour and 3D colour effect, the viewing angle difference may be slightly adjusted depending on the building (or other object) heights or the relief height difference on the ground.

For normal images, such as those displayed on a standard computer monitor, if the parallax of a building is smaller than 0.5mm on a combined 2D/3D image according to the present invention, the human eye will not easily detect it when viewing the 2D image. Consequently, the image has a 2D effect like a normal 2D image. Satellite images with a resolution of 1 m are suitable to produce image maps at the scale of 1:5,000. At this scale, a parallax of 0.5 mm is equivalent to 2.5 pixels on a computer monitor. If the stereo image is displayed on a computer monitor (72 dpi), the human eye will not easily detect parallaxes of less than 2 pixels. In the preferred embodiment, a nadir image and a backward image are used. Referring to FIG. 3b, the relationship between viewing angle α (the backward angle), building height (h) and parallax (p) can be described with the following formula:

$$tan α = \frac{p}{h}$$

When a parallax criterion of 2.5 pixels is used, the relationship between viewing angle (α) and building height is as follows:

| | | | | | | | | | | | |
|---|---|---|---|---|---|---|---|---|---|---|---|
| Building height | 10 | 20 | 30 | 40 | 50 | 60 | 70 | 80 | 90 | 100 | 110 |
| (m) | | | | | | | | | | | |
| Viewing angle | 14 | 7.1 | 4.8 | 3.6 | 2.9 | 2.4 | 2.0 | 1.8 | 1.6 | 1.4 | 1.3 |
| (deg) | | | | | | | | | | | |

For residential areas with mainly family houses, a viewing angle of about 5 degrees is suggested. For city areas with mainly large buildings, a viewing angle of 3 degrees is recommended. For high-rise building areas, such as in the downtowns of North American cities, a viewing angle of 1.5 degrees is suggested. The suggested viewing angles are approximate values calculated using the assumption that 1:5,000 stereo image maps are used.

Relationships Between Image Scales and Parallaxes

In addition to being dependent on the height of buildings in an image, the ideal parallax dimension is also related to the nature of the terrain as well as the size and scale of the image. This relation is explained in Examples 1 and 2. The “product examples” are examples of products in which the present invention could be used.

### EXAMPLE 1

Generation of Urban 2D/3D Colour Images Using Remote Sensing Imagery with a Resolution Between 0.2 and 2.0 m:

| | Ideal parallax | |
|---|---|---|
| Image scale | size | product example |
| 1:10,000 | 0.05-0.5 mm | pocket book |
| 1:5,000 | 0.1-1.0 mm | image maps, video |
| | | screen, computer screen, |
| | | magazine |
| 1:2,500 | 0.2-2.0 mm | wall poster |

The parallax size is in direct proportion to the image scale. For different display purposes, the image scale can be changed. Consequently, the parallax size should also be changed. For example, if the scale is enlarged by multiplying a number of two (scale×2), the parallax size should also be multiplied by two parallax size×2). And vice versa.

### EXAMPLE 2

Generation of Mountainous 2D/3D Colour Images Using Remote Sensing Imagery with a Resolution Between 5 and 20 m:

| | Ideal parallax | |
|---|---|---|
| Image scale | size | product example |
| 1:100,000 | 0.05-0.5 mm | pocket book |
| 1:50,000 | 0.1-1.0 mm | image maps, video |
| | | screen, computer screen, |
| | | magazine |
| 1:25,000 | 0.2-2.0 mm | wall poster |

The parallax size is in direct proportion to the scale. For different display purposes, the image scale can be changed. The relationship between parallax size and scale is the same as in Example 1.

By using remote sensing imagery with a resolution between 2 and 5 m, the suitable scale of a 2D/3D colour image for a desk publication is around 1:15,000 and the parallax size is between 0.1 and 1.0 mm. For different display purposes, the image scale can be changed; however, the parallax size should also be changed in direct proportion to the scale and the viewing distance. It is understood, however, that the parallax size cannot be zero because without parallax a 3D effect cannot be seen.

By using imagery with a resolution of around 50 m, the suitable scale of a 2D/3D colour image for a desk publication is around 1:250,000 and the parallax size is between 0.1 and 1.0 mm.

Method of Production using Frame Sensors

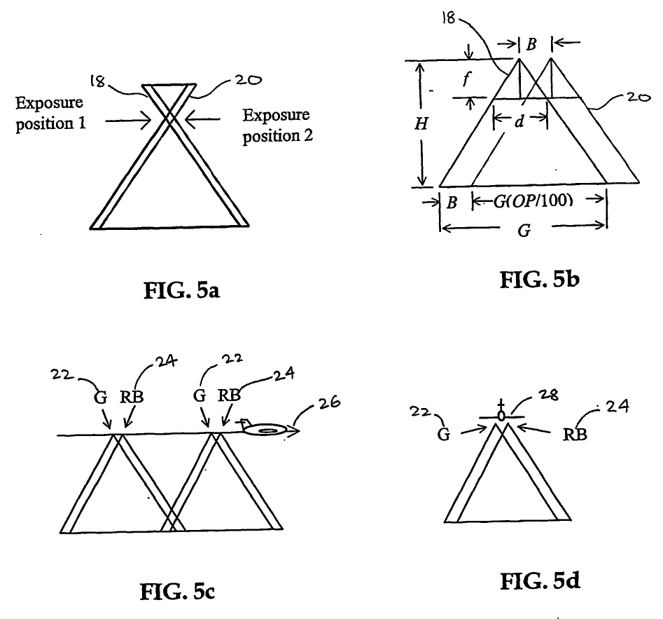

Frame sensors can also be used to produce combined 2D/3D images. One photo 18 is taken with two colour bands from a first exposure position and another photo 20 is taken with another colour band at a second slightly different exposure position (see FIG. 5a). The two photos of a stereo pair should be both vertical photos (optical axis perpendicular to the ground), so that the scale difference in the overlapped area can be minimized. The exposure stations of the two photos should be dose to each other, so that the angle between the two light rays from the two exposure stations to any object in the overlapped area can be kept sufficient small. Because the depth/distance ratio (the ratio of object depth to object distance) is relatively small for airborne or spaceborne images, the variance of the view angles between different objects is small over the whole overlap area. These conditions result in small and substantially constant parallaxes throughout the overlap area. Therefore, the 2D colour image is substantially clear to the eye and a 3D effect can also be seen.

The optimal distance between the two exposure positions is influenced by the flying height of the airplane, the object heights on the ground and the focal length of the camera. However, if the parallaxes of most objects in the image can be kept less than 1 mm in the overlapped area by adjusting the exposure distances, a 2D and 3D colour image can be generated. Referring to FIG. 5b, by fixing the parallaxes p_{relief} to a value of less than or equal to 1 mm in the image, the optimal exposure distance B (also called airbase) can be calculated by using the following equation when the flying height H, focal length f and the average height of most objects h in the photo area are known:

$$B = \frac{( H - h ) \times H \times {p}_{relief}}{f \times h}$$

The following equation can be used to determine the optimal overlap percentage (OP) of a stereo pair for generating combined 2D/3D colour images when the size of the photo (d) is also known:

$$\frac{OP}{100} = 1 - \frac{( H - h ) {p}_{relief}}{d h}$$

For example, suppose that the camera used for 2D/3D imaging has a focal length of 152 mm and a photo size of 32 cm×32 cm, and suppose that the flying height is 1,000 m and the average building heights is 30 m on the ground. Then, the optimal overlap percentage (OP) for 2D/3D imaging (p_{relief}<1 mm) should be equal to or less than 89%. (e.g, if f=152 mm, d=320 mm, H=1,000 m, h=30 m, and p_{relief}≦1 mm, then OP≦89%).

The relationship between airbase B and overlap percentage OP can be seen in FIG. 15b. The stereo pair 22, 24 (taken with green, and red and blue bands respectively), can be taken along the flying track 26 (see FIG. 5c) or across the flying track 28 (see FIG. 5d).

However, using a frame sensor, 2D and 3D colour mosaics cannot be generated because the 3D image on the left part of the mosaicing boundary is from the left photo pair, that on the right part from right pair, and there is no good stereo effect in the middle.

Method for Combining 2D/3D Colour Images

Once the required colour image bands are obtained, the generation of the 2D/3D colour images can be performed using many commercial software tools such as PCI and ERDAS—the most widely used remote sensing and image processing software products. Using image registration tools of the software products, such as GCP Works of PCI or other geometric correction tools, the image bands acquired from two different viewing angles can be registered to a same datum. It is important to just register the corresponding features on the ground, but not on the top of an object in order to preserve 3D effect.

If it is found that when an image pair is registered using corresponding features on the ground, the resulting parallax at the top of tall objects is perceptible when the 2D image is viewed, the position of one image from the registered image pair can be moved slightly (e.g., 1 to 5 pixels depending upon image scale) along the parallax direction to reduce the absolute parallax sizes of some high objects. By doing this, parallaxes will be introduced into objects on the ground in an opposite direction. However, the overall absolute parallaxes throughout the 2D/3D image will be reduced, so that the 2D colour image will appear clearer. This image shift does not reduce the 3D colour effect. Commercial software such as PhotoShop and Corel Photo Paint contain the functions to shift individual bands within one colour image.

Modem remote sensing systems, such IKONOS, may provide image bands that have been registered. For such images, the image registration step may be omitted.

Method of Production Using Image Fusion Methods

The present invention can also be used to generate colour 2D and 3D images using high resolution satellite and airborne CCD imagery. The commercial high resolution satellite sensors can collect stereo image pairs at viewing angles according to the invention. Multispectral image bands (blue, green, red and near infrared) with a 4 m resolution and panchromatic band with a 1 m resolution are available from such satellites. Commercially available image fusion methods can fuse the multispectral and the panchromatic images to produce pan-sharpened (1-m) multispectral images. These pan-sharpened images can be used to generate high-resolution (1 m) 2D/3D colour images.

The available image fusion methods are, for example: the SVR (Synthetic Variable Ratio), IHS (Intensity, Hue, Saturation) and PCA (Principal Component Analysis) techniques. The SVR method reproduces the colour of the multispectral image better than the widely used HIS and PCA techniques (Zhang, Yun 1999: A New Method for Merging Multispectral and Multiresolution Satellite Data and Its Spectral and Spatial Effects. International Journal of Remote Sensing, Vol. 20, No. 10, pp. 2003-2014). The spatial effect of the SVR technique is as good as the two conventional techniques.

Further Advantages

The present invention permits the appearance of a 2D colour image and a 3D colour image of the same objects on one piece of paper or on one computer screen, or simultaneously on another medium such as a piece of cloth or a mouse pad. The invention adds a totally new function to image maps, i.e. one image map can be used for both 2D measuring and colour 3D viewing at the same time. The stereo glasses for colour 3D viewing are inexpensive. Therefore, the 2D/3D colour images/image maps have wide application potential in areas where image maps are demanded (particularly in urban areas) and in the fields of regional planning, real estate, tourism, entertainment, agriculture, forestry, military intelligence,etc. The potential applications arising from the use of commercial high-resolution satellite imagery to generate the 2D/3D colour images/image maps are especially numerous because the high-resolution imagery is available world-wide and the 2D/3D colour images/image maps can be produced for every area in the world.

The invention can also be used to produce some types of 3D digital games. For example, if the invention is applied to a conventional 2D maze game, the game can still be played as a 2D game without using a pair of stereo glasses. However, when the player sees the image through a pair of stereo glasses, he/she will see a colour 3D game. This makes the game more vivid and interesting.

I claim:

1. A combined colour 2D/3D image comprising:
an image medium;
a first image of an object including a first colour band on said medium;
a second image of said object including second and third colour bands said first colour band overlaid on said second and third colour bands and in registration therewith sufficient to achieve parallax whereby the combined image appears as a substantially dear 2D image when viewed without a complementary colour filter and as a 3D image when viewed with such a filter.

2. A combined 2D/3D image according to claim 1, wherein said first image is from a first viewing angle and said second image is from a second viewing angle with respect to the object.

3. A combined 2D/3D image according to claim 1, wherein said first and second images are vertical images.

4. A combined 2D/3D image according to claim 1, wherein said parallax is substantially constant throughout the combined 2D/3D image.

5. A combined 2D/3D image according to claim 1, wherein said first and second images are selected from the group comprising spaceborne images and airborne images.

6. A combined 2D/3D image according to claim 1, wherein said parallax is between 0 mm and 0.5 mm.

7. A combined 2D/3D image according to claim 1, wherein said colour bands are blue, green and red.

8. A combined 2D/3D image according to claim 1, wherein said first image is a nadir image and said second image is a tilted image.

9. A combined 2D/3D image according to claim 1, wherein said first colour band is green and said second and third colour bands are red and blue, respectively.

10. A combined 2D/3D image according to claim 1, wherein said first image is a tilted image and said second image is a nadir image.

11. A combined 2D/3D image according to claim 1, wherein said first colour band is red and said second and third colour bands are green and blue respectively.

12. A combined 2D/3D image according to claim 1, wherein said parallax is between 0.5 and 2.0 mm.

13. A method for forming a combined 2D/3D colour image of an object comprising the steps of:
producing a first image of said object from a first viewing angle using a first colour band;
producing a second image of said object from a second viewing angle using second and third colour bands;
overlaying and registering said first and second images on a medium, being such that the colour image appears as a substantially dear 2D image when viewed with a complementary filter, and as a 3D image when viewed with such a filter.

14. A method according to claim 13, wherein said first image is a nadir image.

15. A method according to claim 13, wherein said second image is a tilted image.

16. A method according to claim 15, wherein the difference between said first and second viewing angles is between 0 and 5 degrees.

17. A method according to claim 15, wherein the difference between said viewing angles is between 1.3 and 14 degrees.

18. A method according to claim 15, wherein the difference between said viewing angles is between 0 and 3 degrees.

19. A method according to claim 15, wherein the difference between said viewing angles is 1.5 degrees.

20. A method according to claim 13, wherein said registering includes the step of registering corresponding features of said object to the same datum.

21. A method according to claim 20, wherein said registering includes the step of registering corresponding features on the ground.

22. A method according to claim 13, including the step of shifting said first colour band along the parallax direction, whereby the absolute parallax sizes of said object is reduced.

23. A method of collecting a ground image pair using an airborne or spaceborne sensor comprising the steps of:
producing a first image of the ground from a first viewing angle;
producing a second image of the ground from a second viewing angle,
wherein the angular difference between said viewing angles is between 1.3 and 14 degrees.

24. A method according to claim 23, wherein said angular difference is between 0 and 5 degrees.
